(19) United States
(12) Patent Application Publication
(10) Pub. No.: US 2020/0065468 A1
(43) Pub. Date: Feb. 27, 2020

(54) PASSWORD AUTHENTICATION DEVICE

(71) Applicant: KYOCERA Document Solutions Inc., Osaka (JP)

(72) Inventor: Masafumi TSUTSUMI, Osaka-shi (JP)

(73) Assignee: KYOCERA Document Solutions Inc., Osaka (JP)

(21) Appl. No.: 16/534,409

(22) Filed: Aug. 7, 2019

(30) Foreign Application Priority Data
Aug. 24, 2018 (JP) 2018-157136

(51) Int. Cl. G06F 21/36; G06F 3/0488

(52) U.S. Cl. CPC G06F 21/36; G06F 3/04883

(57) ABSTRACT

A password authentication device includes a touch screen, a character assignment section, a verification section, and an authentication section. The touch screen displays a login authentication prompt where operation keys allowing entering an input password being password composed of a combination of acceptable password characters are arranged. When touch on any operation key of the operation keys is detected, the character assignment section randomly assigns characters including a character, of corresponding registration password, of the acceptable password characters to different operation keys other than the operation key that touch thereon is detected. Linear slide movement to different operation keys is allowed from the operation key that touch thereon is detected. The verification section verifies the input password entered through the slide movement based on the corresponding registration password. When the input password matches the corresponding registration password, the authentication section executes a login process.

### INCORPORATION BY REFERENCE

The present application claims priority under 35 U.S.C. § 119 to Japanese Patent Application No. 2018-157136, filed on Aug. 24, 2018. The contents of this application are incorporated herein by reference in their entirety.

### BACKGROUND

The present disclosure relates to a password authentication device that performs user authentication with passwords entered.

Image forming apparatuses such as copiers, printers and multifunction peripherals, and information processing devices such as computers may be equipped with a user authentication function with passwords. It is necessary to prevent password leakage to third parties from the viewpoint of ensuring security.

### SUMMARY

A password authentication device according to an aspect of the present disclosure includes a touch screen, a character assignment section, a verification section, and an authentication section. The touch screen displays a login authentication prompt where operation keys are arranged. The operation keys allow entering an input password that is a password composed of a combination of acceptable password characters. When touch on any operation key of the operation keys is detected, the character assignment section randomly assigns characters to different operation keys other than the operation key that the touch thereon is detected. The characters assigned include a character, of a corresponding registration password, of the acceptable password characters. Linear slide movement to the different operation keys is allowed from the operation key that the touch thereon is detected. The verification section verifies the input password entered through the slide movement based on the corresponding registration password. When the input password matches the corresponding registration password, the authentication section executes a login process.

### BRIEF DESCRIPTION OF THE DRAWINGS

FIG. 1 is a block diagram illustrating a schematic configuration of a password authentication device according to the present embodiment.

FIG. 2 depicts an example of a login authentication prompt displayed on a touch screen illustrated in FIG. 1.

FIG. 3A depicts an example of the login authentication prompt displayed on the touch screen illustrated in FIG. 1.

FIG. 3B depicts an example of the login authentication prompt displayed on the touch screen illustrated in FIG. 1.

FIG. 4A depicts an example of the login authentication prompt displayed on the touch screen illustrated in FIG. 1.

FIG. 4B depicts an example of the login authentication prompt displayed on the touch screen illustrated in FIG. 1.

FIG. 5 depicts an example of arrangement information illustrated in FIG. 1.

FIG. 6A is a flow chart illustrating a login operation by the password authentication device according to the present embodiment.

FIG. 6B is a flow chart illustrating a login operation by the password authentication device according to the present embodiment.

FIG. 7A depicts an example of password input with respect to the password authentication device according to the present embodiment.

FIG. 7B depicts an example of password input with respect to the password authentication device according to the present embodiment.

FIG. 7C depicts an example of password input with respect to the password authentication device according to the present embodiment.

FIG. 7D depicts an example of password input with respect to the password authentication device according to the present embodiment.

FIG. 7E depicts an example of password input with respect to the password authentication device according to the present embodiment.

### DETAILED DESCRIPTION

An embodiment of the present disclosure will now be described with reference to the drawings.

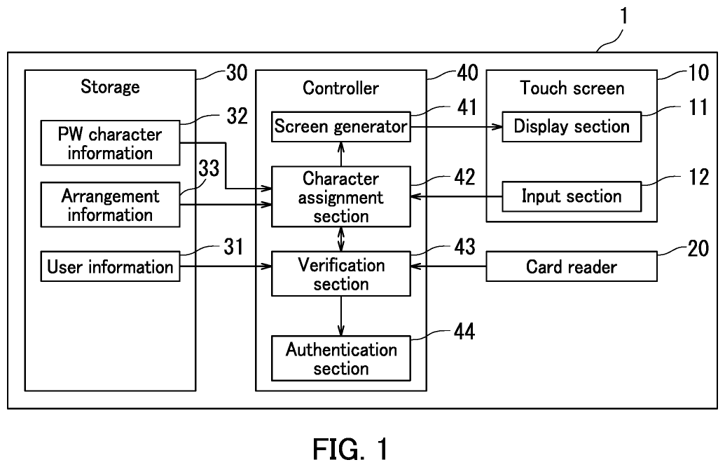

A password authentication device 1 according to the present embodiment is a device that verifies a password entered (hereinafter referred to as an “input password”) based on a corresponding password registered (hereinafter referred to as a “corresponding registration password”), thereby performing user authentication. Referring to FIG. 1, the password authentication device 1 includes a touch screen 10, a card reader 20, storage 30, and a controller 40.

The touch screen 10 is provided with a transparent pressure sensor on a surface of a display panel such as a liquid crystal panel. The display panel of the touch screen 10 functions as a display section 11 that displays different operation keys. The pressure sensor of the touch screen 10 functions as an input section 12 that receives respective operations through the different operation keys.

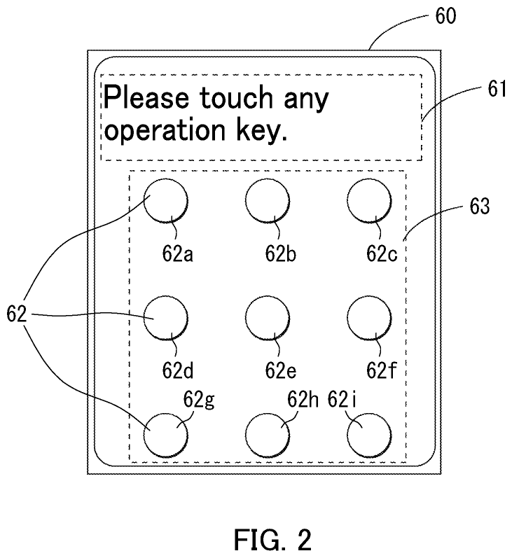

The touch screen 10 displays a login authentication prompt 60 that receives input of passwords. As illustrated in FIG. 2, the login authentication prompt 60 contains an on-screen input guidance 61 and an on-screen input 63. The on-screen input 63 is disposed below the on-screen input guidance 61. The on-screen input 63 is provided with operation keys 62 for password input. The operation keys 62 are to be assigned respective characters in response to a user operation. Note that the operation keys 62 are not assigned the characters entered through the operation in advance, but assigned respective characters in response to a password input status.

In this example, the number of the operation keys 62 is nine, and the operation keys 62 are arranged in 3 rows and 3 columns. The operation keys 62 may include a first operation key 62a, a second operation key 62b, a third operation key 62c, a fourth operation key 62d, a fifth operation key 62e, a sixth operation key 62f, a seventh operation key 62g, an eighth operation key 62h, and a ninth operation key 62i. On the first row, the first, second, and third operation keys 62a, 62b, and 62c are arranged from left to right in that order. On the second row, the fourth, fifth, and sixth operation keys 62d, 62e, and 62f are arranged from left to right in that order. On the third row, the seventh, eighth, and ninth operation keys 62g, 62h, and 62i are arranged from left to right in that order. On the first column, the first, fourth, and seventh operation keys 62a, 62d, and 62g are also arranged from top to bottom in that order. On the second column, the second, fifth, and eighth operation keys 62b, 62e, and 62h are arranged from top to bottom in that order. On the third column, the third, sixth, and ninth operation keys 62c, 62f, and 62i are arranged from top to bottom in that order. Note that in the present embodiment, the operation keys 62 are nine in number and arranged in 3 rows and 3 columns as illustrated in FIG. 2, but the number and arrangement of the operation keys 62 may be changed as appropriate.

In FIG. 1, the card reader 20 functions as a user ID input section that reads a user ID for identifying a user from a user's card such as an employee ID card. Another reader that reads user's biometric information such as a fingerprint(s) may be provided in place of the card reader 20, thereby identifying the user ID. In addition, an input section of the touch screen 10 or the like may receive the user ID.

The storage 30 is a storage means such as semiconductor memory. The storage 30 stores user information 31, password (PW) character information 32, and arrangement information 33.

The user information 31 is provided as an information set that contains user IDs for identifying respective users, registration passwords, and plural pieces of operation hand information that indicate whether respective users' hands by which their respective input passwords are to be entered are the right hand or the left hand. The user IDs, the registration passwords, and the plural pieces of operation hand information are associated with or related to each other, and registered to the user information 31. Part of the user information 31 is to be stored in the storage section 30 at the time of initial setting or when a corresponding user(s) is(are) newly registered.

The PW character information 32 contains acceptable password characters that are available for passwords. Hereinafter, the acceptable password characters are referred to as “PW characters”, while one of the acceptable password characters are referred to as “PW character”. Examples of characters registered as the PW character information 32 include alphanumeric characters, numeric digits, and symbols. Note that in the present embodiment, the PW characters registered in the PW character information 32 are numeric digits “0” to “9”, and each password is a four-digit combination of numeric digits “0” to “9” in the PW characters.

Note that in FIG. 2, after any of the first to ninth operation keys 62a to 62i is touched, the PW character is to be entered according to any of the first to ninth operation keys 62a to 62i touched. A first character of the input password may, however, be entered as a result of any of the first to ninth operation keys 62a to 62i being touched.

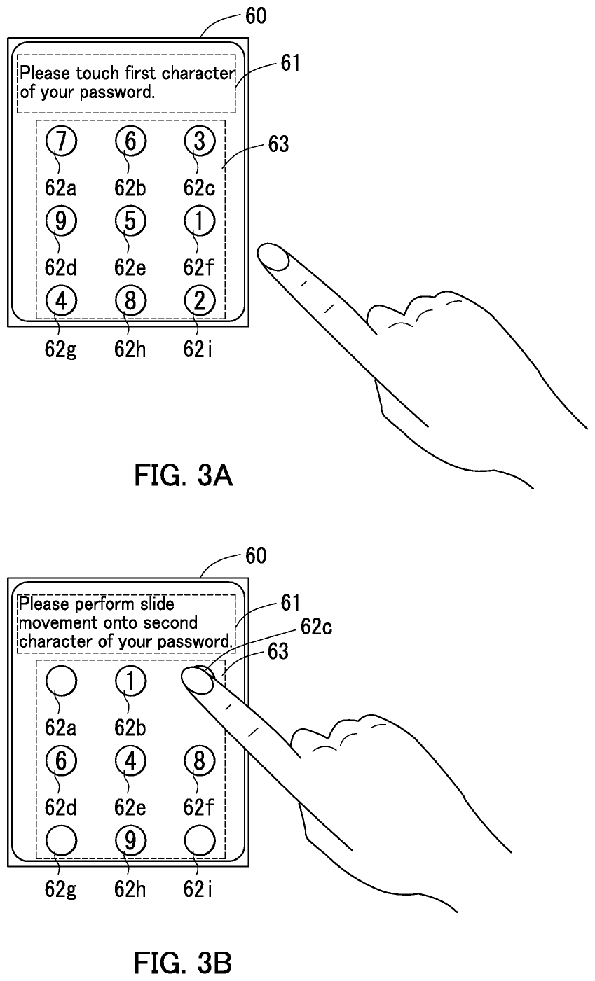

As illustrated in FIG. 3A, the on-screen input guidance 61 displays thereon a message that prompts touch on an operation key 62 corresponding to the first character. At this stage, the on-screen input 63 is randomly assigned nine numeric digits so that the nine numeric digits each correspond to one of the first to ninth operation keys 62a to 62i.

In this example, the first operation key 62a, the second operation key 62b, and the third operation keys 62c are assigned a numeric digit “7”, a numeric digit “6”, and a numeric digit “3”, respectively. The fourth operation key 62d, the fifth operation key 62e, and the sixth operation key 62f are also assigned a numeric digit “9”, a numeric digit “5”, and a numeric digit “1”, respectively. In addition, the seventh operation key 62g, the eighth operation key 62h, and the ninth operation key 62i are assigned a numeric digit “4”, a numeric digit “8”, and a numeric digit “2”, respectively.

It is herein assumed that a user touches the third operation key 62c assigned numeric digit “3” with at least a finger of the right hand. Hereinafter, at least a finger of user's hand, the right hand, or the left hand is also simply referred to as user's hand, the right hand, the left hand or the like, respectively. In this case, the content of the login authentication prompt 60 is then changed.

As illustrated in FIG. 3B, the on-screen input guidance 61 displays thereon a message that prompts touch onto an operation key 62 corresponding to a second character of the input password. At this stage, the on-screen input 63 is randomly assigned numeric digits so that the numeric digits correspond to the respective operation keys. In this example, the numeric digits assigned to the operation keys include a numeric digit, which is a character in question of the corresponding registration password, of nine numeric digits. Note that the assignment in the case of the on-screen input 63 that prompts touch onto the second character differs from the assignment in the case of the on-screen input 63 that prompts touch onto the first character. In addition, in the case of the second character, it is unnecessary to assign all of the operation keys 62 respective numeric digits. For example, of all of the operation keys 62, specified operation keys 62 are assigned numeric digits according to the position of an operation key touched, while the other operation keys 62 do not need to be assigned any numeric digits.

In this example, the second operation key 62b is assigned a numeric digit “1”. The fourth, fifth, and sixth operation keys 62d, 62e, and 62f are also assigned numeric digits “6”, “4”, and “8”. The eighth operation key 62h is also assigned a numeric digit “9”.

In contrast, the third operation key 62c touched in order to enter the first character is not assigned any numeric digit. This is because the third operation key 62c remains touched with the user's right hand, and there is a high possibility that the use cannot see the numeric digit of the third operation key 62c.

The first operation key 62a is also not assigned any numeric digit. This is because the second operation key 62b is located between the third and first operation keys 62c and 62a, and for linear slide from the third operation key 62c to the first operation key 62a, another second operation key 62b needs to be touched before reaching the first operation key 62a. Similarly, linear slide without being disturbed by any intermediate operation key is not allowed from the third operation key 62c to each of the seven and ninth operation keys 62g and 62i. Thus, of all of the operation keys 62, the first, seventh, and ninth operation keys 62a, 62g, and 62i to which linear slide movement is not allowed from the third operation key 62c.

The operation key 62 corresponding to the second character is then touched. This examples allows the user's right hand to slide in a linear manner from the third operation key 62c to any of the second, fourth, fifth, sixth, and eighth operation keys 62b, 62d, 62e, 62f, and 62h, thereby touching any of numeric digits “1”, “6”, “4”, “8”, and “9”.

Note that although as described with reference to FIGS. 3A and 3B, the operation keys assigned no numeric digits are determined according to the position of the operation key touched, the present embodiment is not limited thereto. Of all of the operation keys 62, specified operation keys assigned no numeric digits may be determined according to a user's hand used for a touch operation.

Furthermore, an operation key at a reference position before the first character is entered does not need to be assigned any numeric digit. For example, of all of the operation keys 62, the center operation key does not need to be assigned any numeric digit.

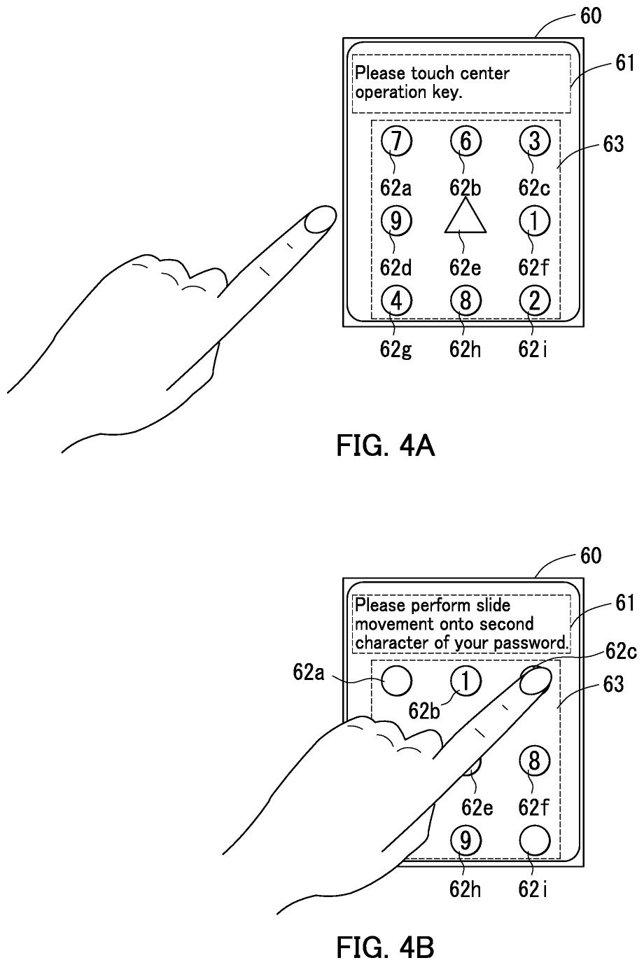

As illustrated in FIG. 4A, the on-screen input guidance 61 displays a message that prompts touch onto an operation key 62. In this example, the on-screen input guidance 61 displays a message that prompts touch onto a center operation key 62, or the fifth operation key 62e. At this stage, in the on-screen input 63, eight numeric digits are randomly assigned so that the eight numeric digits correspond to the first to fourth operation keys 62a to 62d, and the sixth to ninth operation keys 62f to 62i. In this example, the user's operation hand is the left hand.

The first, second, and third operation keys 62a, 62b, and 62c are assigned numeric digits “7”, “6”, and “3”, respectively. The fourth, and sixth operation keys 62d and 62f are also assigned numeric digits “9” and “1”, respectively. The seventh, eighth, and ninth operation keys 62g, 62h, and 62i are also assigned numeric digits “4”, “8”, and “2”, respectively. In this example, the fifth operation key 62e is however assigned no numeric digit. In this case, it is preferable that a displayed manner of the fifth operation 62e be different from a display manner of the first to fourth operation keys 62a to 62d, and the sixth to ninth operation keys 62f to 62i.

Note that preferably such an operation key 62 assigned no numeric digit be a center operation key 62, or the fifth operation key 62e of all of the operation keys 62. This case enables an increase in the number of operation keys, of all of the operation keys 62, to which linear slide movement is allowed from the fifth operation key 62e, thereby preventing malicious third parties who do not know the registration password from easily estimating the registration password.

It is herein assumed that the user touches the fifth operation key 62e with the left hand. In this case, the content of the login authentication prompt 60 is then changed. The on-screen input guidance 61 displays, but not illustrated herein, a message that prompts touch onto an operation key 62 assigned the first character. Note that the display of the on-screen input 63 prompting touch onto the first character does not change. It is assumed that the user subsequently touches the third operation key 62c assigned the numeric digit “3” with the left hand. In this case, the content of the login authentication prompt 60 is then changed.

As illustrated in FIG. 4B, the on-screen input guidance 61 displays a message that prompts touch onto an operation key 62 assigned the second character. At this stage, in the on-screen input 63, some operation keys are assigned respective numeric digits so that the numeric digits correspond to the respective operation keys. In this example, the numeric digits assigned to the operation keys include a numeric digit that is one of nine numeric digits and is at a position in question in the registration password. The assignment in the case of the on-screen input 63 prompting touch onto the second character, however, differs from the assignment in the case of the on-screen input 63 prompting touch onto the first character. Note that the assignment of numeric digits in the on-screen input 63 prompting touch onto the second character does not need to be performed with respect to all of the operation keys 62. For example, of all of the operation keys 62, specified operation keys 62 may be assigned respective numeric digits according to the position of an operation key touched.

In this example, the second operation key 62b is assigned a numeric digit “1”. The sixth and eighth operation keys 62f and 62h are also assigned numeric digits “8” and “9”, respectively.

In contrast, the third operation key 62c touched when the first character is entered is assigned no numeric digit. This is because the third operation key 62c remains touched with the user's left hand, and there is a high possibility that the user cannot see the numeric digit assigned to the third operation key 62c.

The first operation key 62a is also assigned no numeric digit. This is because the second operation key 62b is located between the third and first operation keys 62c and 62a, and for liner slide from the third operation key 62c to the first operation key 62a, a different operation key, or the second operation key 62b is necessarily touched before reaching the first operation key 62a. Similarly, linear slide from the third operation key 62c to each of the seventh and ninth operation keys 62g and 62i is not allowed. In this way, of all of the operation keys 62, the first, seventh, and ninth operation keys 62a, 62g, and 62i to which linear slide movement is not allowed from the third operation key 62c are not assigned any numeric digits.

Furthermore, the fourth and fifth operation keys 62d and 62e are also not assigned any numeric digits. This is because the fourth and fifth operation keys 62d and 62e are hard to be visually recognized due to the presence of the user's left hand.

The operation key 62 assigned the second character is then touched. The embodiment allows the user's left hand to slide in a linear manner from the third operation key 62c to any of the second, sixth, and eighth operation keys 62b, 62f, and 62h, thereby selecting any of numeric digits “1”, “8”, and “9”.

As can be seen from comparison with FIGS. 3B and 4B, even in the case where the same third operation key 62c is touched, if the user touches the third operation key 62c with the right hand, respective numeric digits are not assigned to, of all of the operation keys 62, the first, seventh, and ninth operation keys 62a, 62g, and 62i to which linear slide movement thereof is not allowed. In contrast, if the user touches the third operation key 62c with the left hand, respective numeric digits are not assigned to, of all of the operation keys 62, not only the first, seventh, and ninth operation keys 62a, 62g, and 62i to which linear slide movement thereof is not allowed, but also the fourth and fifth operation keys 62d and 62e to be hidden with the operation hand. Thus, the operation keys not assigned any numeric digits may change according to the operation hand.

In FIG. 1, the arrangement information 33 contains operation keys 62 that are set not to allow character assignment for each of an operation hand (left or right hand) and an operation key touched (an operation key 62 which a user touches). Examples of the operation keys 62 that are set not to allow character assignment include operation keys 62 to which linear slide movement is not allowed from a corresponding operation key touched, and invisible operation keys 62 that are hidden in a corresponding operation hand. Note that such slide movement means movement of a user's finger with the finger touching the touch screen 10.

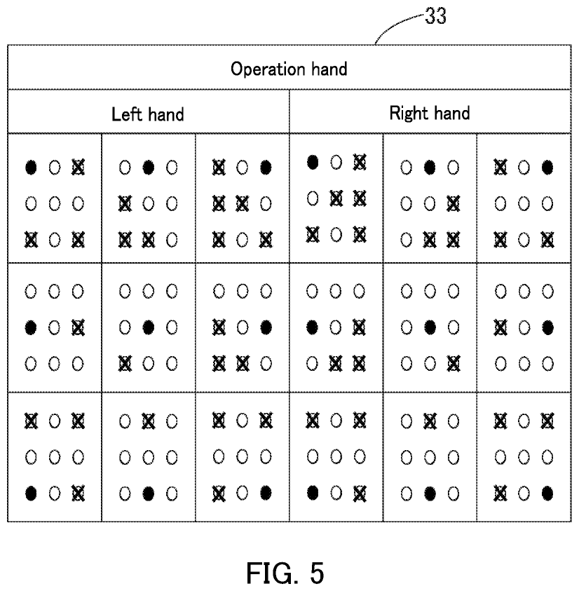

In FIG. 5, each black circle “●” represents an operation key touched, and each mark provide with “X” represents an operation key 62 to which assignment of a numeric digit is prohibited. Examples of the arrangement information 33 may also include operation keys 62 that allow respective characters to be assigned thereto for each of an operation hand and an operation key touched. That is, the arrangement information 33 may include, of operation keys 62 to which linear slide movement is allowed from an operation key touched, visible operation keys 62 without being hidden in an operation hand.

The controller 40 is an information processor such as a microcomputer including CPU, ROM, RAM and the like. The ROM stores a control program for performing an operation control of the password authentication device 1. The CPU of the controller 40 reads the control program stored in the ROM, and loads the control program into the RAM, thereby performing control of the entire device. The controller 40 also functions as a screen generator 41, a character assignment section 42, a verification section 43, and an authentication section 44.

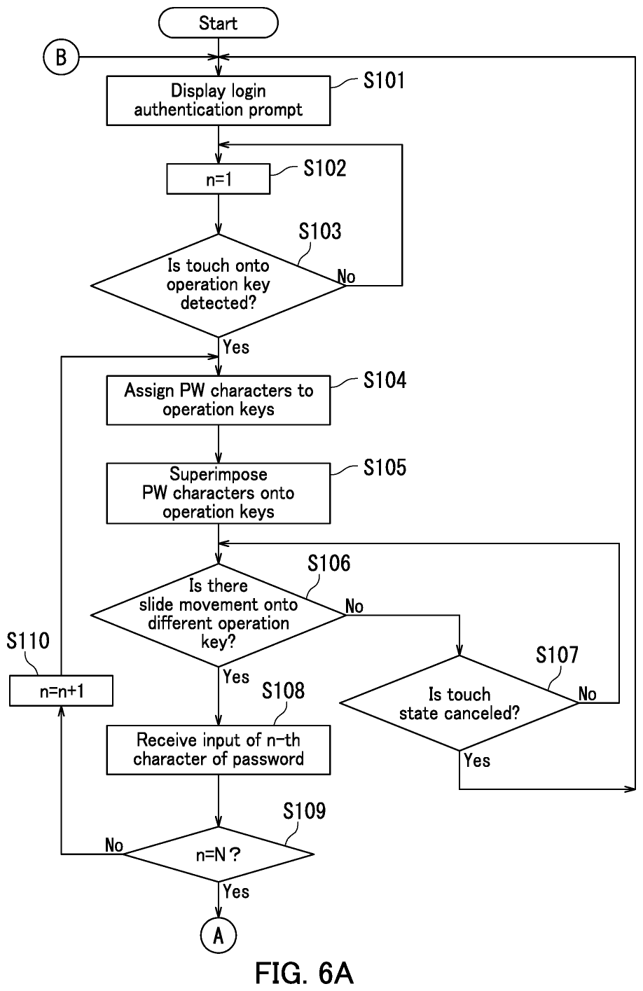

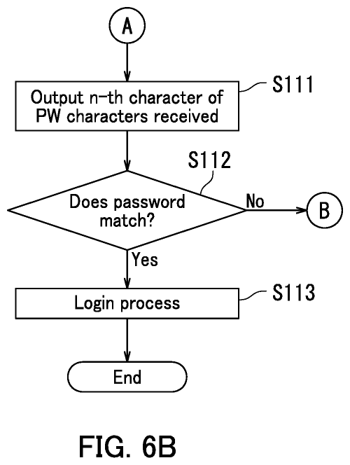

A password authentication operation by the password authentication device 1 will next be described in detail with reference to FIGS. 6A and 6B. Each of FIGS. 6A and 6B is a flow chart illustrating the password authentication operation by the password authentication device 1.

The card reader 20 reads a user ID, and the verification section 43 then reads a registration password and operation hand information that are associated with the user ID, thereby providing the registration password and the operation hand information to the character assignment section 42.

As illustrated in FIG. 2, the screen generator 41 then causes the display section 11 to display an initial login authentication prompt 60 in which the operation keys 62 are not assigned any characters, with a message that prompts touch onto any operation key 62 displayed on the on-screen input guidance 61 (step S101).

The character assignment section 42 then sets a variable “n” to “1” (step S102), and waits to detect touch onto any operation key 62 by a user (step S103).

At step S103, the input section 12 detects the touch onto an operation key 62 (“Yes” at step S103). Based on the operation key touched and corresponding operation hand information as well as the PW character information 32 and the arrangement information 33, the character assignment section 42 randomly assigns, to operation keys 62 that allow respective characters of the PW characters to be assigned thereto, the respective PW characters including at least a PW character that is an n-th character of a corresponding registration password (step S104). Note that the operation keys 62 that allow respective characters of the PW characters to be assigned thereto correspond to, of operation keys 62 to which linear slide movement is allowed from the operation key touched, visible operation keys 62 without being hidden in an operation hand.

The character assignment section 42 then notifies the screen generator 41 of an assignment result of characters of the PW characters including n-th character. The screen generator 41 then superimposes the assigned characters of the PW characters onto respective operation keys 62, while displaying, on the on-screen input guidance 61, a message that prompts slide movement onto the PW character of the n-th character to be entered (step S105).

The character assignment section 42 detects movement onto a different operation key 62 by the slide movement (step S106), and also detects whether or not the touch state is canceled, or whether or not the operation hand leaves the touch screen 10 (S107).

If the touch state canceled is detected at step S107 (“No” at step S107) with the movement onto the different operation key 62 not detected at step S106 (“No” at step S106), the process returns to step S101.

If the movement onto the different operation key 62 is detected at step S106 (“Yes” at step S106), the character assignment section 42 receives the n-th character of the password (step S108), and determines whether or not the variable “n” reaches the character number N of the password (step S109).

If the variable “n” does not reach the character number N of the password at step S109 (“No” at step S109), the increment of the variable “n” is performed by “1” (step S110), and the process then returns to step S104. Steps S104 to S108 are then repeated N times, and the character assignment section 42 then receives N-digit characters that is a combination of the PW characters as the input password.

If the variable “n” reaches the character number N of the password at step S109 (“Yes” at step S109), the character assignment section 42 provides the verification section 43 with the “n” characters received that are the combination of the PW characters as the input password (step S111). The verification section 43 then determines whether or not the input password matches the corresponding registration password (step S112).

If the input password does not match the corresponding registration password at step S112 (“No” at step S112), the process returns to step S101.

If the input password matches the corresponding registration password at step S112 (“Yes” at step S112), the authentication section 44 executes a login process (step S113), and the login authentication operation ends. The present embodiment enables easy input of the input password through the linear slide movement, with respective input loci when identical input passwords are entered differing each time, thereby preventing password leakage owing to the finger's movement without compromising convenience.

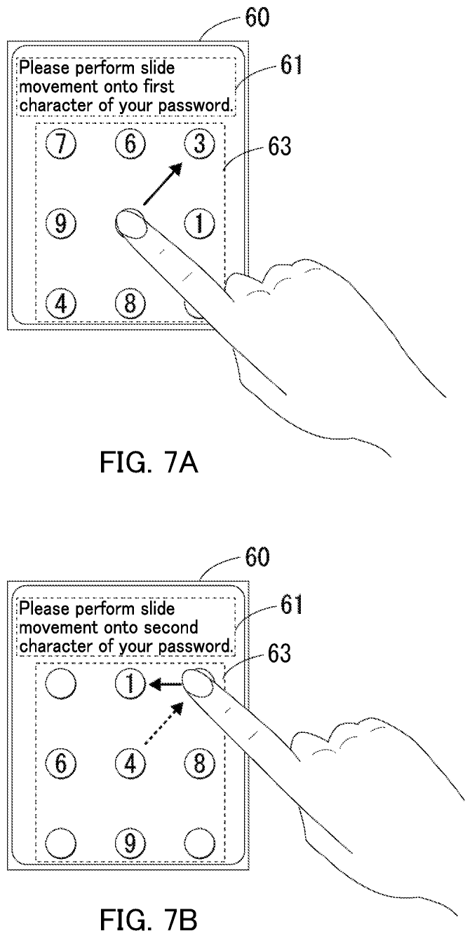

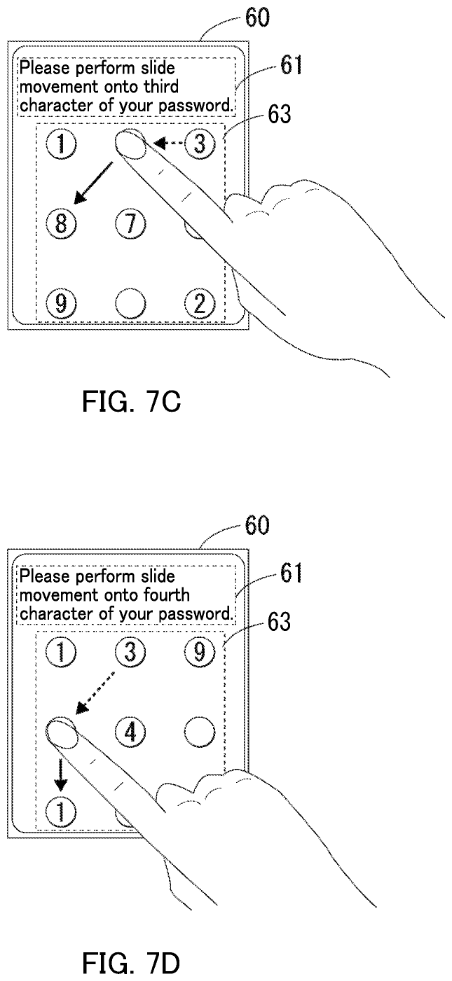

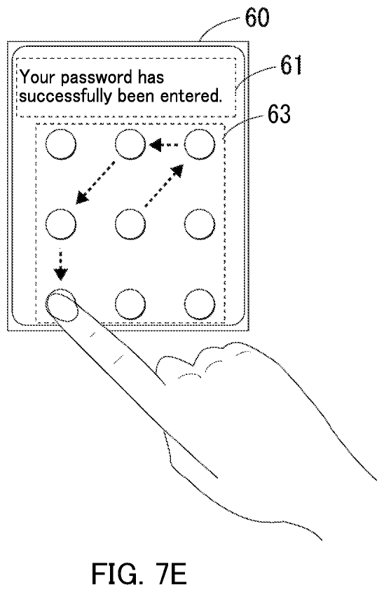

An input example of a password into the password authentication device 1 will next be described in detail with reference to FIGS. 7A to 7E. FIGS. 7A to 7E depict an example where a combination of the PW characters constituting a password are numeric digits and an input password to match the registration password of “3181” will be entered.

In the initial login authentication prompt 60 illustrated in FIG. 2, any operation key 62 is touched, and then operation keys 62 that allow respective characters to be assigned thereto are randomly assigned respective characters of the PW characters, which include the first character “3” of the registration password as illustrated in FIG. 7A. This enables the user to enter the first character “3” of the registration password through linear slide movement from the operation key touched as depicted by the arrow.

Operation keys 62 that allow respective characters to be assigned thereto are randomly assigned respective characters of the PW characters, which include the second character “1” of the registration password as illustrated in FIG. 7B. This enables the user to enter the second character “1” of the registration password through the linear slide movement from the operation key touched.

Operation keys 62 that allow respective characters to be assigned thereto are randomly assigned respective characters of the PW characters, which include the third character “8” of the registration password as illustrated in FIG. 7C. This enables the user to enter the third character “8” of the registration password through the linear slide movement from the operation key touched.

Operation keys 62 that allow respective characters to be assigned thereto are randomly assigned respective characters of the PW characters, which include the fourth character “1” of the registration password as illustrated in FIG. 7D. This enables the user to enter the fourth character “1” of the registration password through the linear slide movement from the operation key touched.

A dotted arrow depicted in FIG. 7E is an input locus of the input password “3181”. As illustrated by this locus, it is possible to easily enter the input password through the linear slide movement. Operation keys 62 that allow respective character to be assigned thereto are randomly assigned respective characters of the PW characters, so that respective input loci when identical input passwords are entered differ each time. It is therefore possible to avoid recognizing the input password from the movement of the user's finger.

Note that in the above-mentioned present embodiment, although the user information 31 is provided as an information set that contains operation hand information for each of users, each piece of operation hand information may be detected through a capturing section such as a camera. In this case, the character assignment section 42 may directly recognize visible operation keys 62 that are not hidden in a user's operation hand without reading corresponding operation hand information from the user information 31.

As described above, the present embodiment describes the password authentication device 1 that verifies an input password that is a password composed of a combination (composed of at least one character) of acceptable password characters (PW characters) based on a corresponding registration password that is a password registered in advance, thereby executing a login process. The password authentication device 1 includes the touch screen 10, the character assignment section 42, the verification section 43, and the authentication section 44. The touch screen 10 displays the login authentication prompt 60 where operation keys 62 for entering the input password are arranged. When touch on any operation key 62 is detected, the character assignment section 42 randomly assigns a combination (composed of at least one character) of the PW characters, which include the next character of the corresponding registration password to different operation keys 62 other than the operation key that the touch thereon is detected, respectively. Linear slide movement to the different operation keys is allowed from the operation key that the touch thereon is detected. Here, “linear” means in the form of a straight line. The verification section 43 verifies the input password entered by the slide movement based on the corresponding registration password. When the input password matches the corresponding registration password, the authentication section 44 executes a login process.

The configuration enables easy input of the input password through the linear slide movement with respective input loci when identical passwords are entered differing each time, thereby preventing password leakage owing to the finger's movement without compromising convenience.

Furthermore, in the present embodiment, the character assignment section 42 randomly assigns respective characters of the PW characters to visible operations keys 62 that is not hidden in the operation hand.

This configuration enables visual recognition of the respective characters of the PW characters assigned to operation keys 62, and smooth input of the input password.

Note that the present disclosure is not limited to the above-mentioned embodiments, and the embodiments may be changed within the scope of the technical ideas of the present disclosure.

What is claimed is:

1. A password authentication device, comprising
a touch screen configured to display a login authentication prompt where operation keys are arranged, the operation keys allowing entering an input password that is a password composed of a combination of acceptable password characters,
a character assignment section configured to, when touch on any operation key of the operation keys is detected, randomly assign characters including a character, of a corresponding registration password, of the acceptable password characters to different operation keys other than the operation key that the touch thereon is detected, linear slide movement to the different operation keys being allowed from the operation key that the touch thereon is detected,
a verification section configured to verify the input password entered through the slide movement based on the corresponding registration password, and
an authentication section configured to execute a login process when the input password matches the corresponding registration password.

2. The password authentication device according to claim 1, wherein
when touch on any operation key of the operation keys is detected, the character assignment section does not assign any character of the acceptable password characters to, of the operation keys, one or more operation keys, disposed at respective one or more positions, to which linear slide movement is not allowed from the operation key that touch thereon is detected.

3. The password authentication device according to claim 1, wherein
the character assignment section randomly assigns any character of the acceptable password characters to, of the operation keys, one or more visible operation keys that are not hidden in an operation hand.

4. The password authentication device according to claim 3, wherein
the character assignment section does not assign any character of the acceptable password characters to, of the operation keys, one or more operation keys disposed at respective one or more positions which are hidden in the operation hand.

5. The password authentication device according to claim 1, wherein
the character assignment section does not assign any character of the acceptable password characters to at least one operation key of the operation keys before touch of any operation key of the operation keys is detected.
